(19) United States
(12) Patent Application Publication
(10) Pub. No.: US 2014/0206595 A1
(43) Pub. Date: Jul. 24, 2014

(54) CLEANING MIXTURE FOR THE REMOVAL OR AVOIDANCE OF INSECT DEPOSITS ON SURFACES

(71) Applicant: EADS Deutschland GmbH, Ottobrunn (DE)

(72) Inventors: Dominik Raps, Muenchen (DE); Silvia Lomolino, Muenchen (DE); Albert Krastanov, Plovdiv (BG); Plamena Nedelcheva, Dobrich (BG)

(73) Assignee: EADS DEUTSCHLAND GMBH, Ottobrunn (DE)

(21) Appl. No.: 14/132,144

(22) Filed: Dec. 18, 2013

(30) Foreign Application Priority Data
Dec. 18, 2012 (DE) 10 2012 112 519.8

(51) Int. Cl. C11D 3/386

(52) U.S. Cl. CPC C11D 3/38636
USPC 510/392

(57) ABSTRACT

A cleaning mixture for the removal or avoidance of insect deposits on surfaces, and particularly for removing the insect deposits from airplane surfaces such as the wings, the fuselage or the tail of an aircraft, includes at least one protease in combination with at least a chitinase and at least a compatible surfactant.

### FIELD OF THE INVENTION

The present invention relates to a cleaning mixture to the removal/prevention of insect deposits on surfaces, preferably aircraft, which includes optional de-icing agents, enzymes and surfactants for the removal/prevention of insect deposits on wings, fuselage and the tail of an aircraft.

### BACKGROUND OF THE INVENTION

There is a need to reduce fuel consumption in aviation for economic and ecological reasons. In the available technique there are different concepts known to the technical people to reduce fuel consumption and to play a decisive role in optimizing aerodynamics.

Reduction of turbulent flows on a plane's surfaces leads to a lower air resistance and thus lower fuel consumption. This way the outer shell of an aircraft, for example the wings, fuselage and tail unit, are designed for the laminar flow to occur. However, in practice, this laminar flow is disturbed by impurities on the outer shell. A rough surface formed by the deposition of dirt on the exterior creates unwanted turbulent flows occur. In addition, water deposits such as ice have impurities mostly of insect deposits. These impurities are disruptive and occur most often between takeoff and reaching the cruising altitude.

Insects consist primarily of two components, i.e. exoskeleton and hemolymph. The exoskeleton creates the covering which consists mainly of the polysaccharide chitin and the structural proteins sclerotin and resilin. The hemolymph contains the viscera and consists of proteins that can act as an adhesive. This is a result of coagulation. When an insect hits the surface at high speed, the exoskeleton breaks and hemolymph leaks out, so the insect deposit sticks to the surface due to the effect of adhesion.

In the existing technique there are various procedures known to meet the problem of insect deposits in the field of aviation.

The DE 3529148 A1 describes a protective foil on a plane's surface, which will be replaced after having reached the cruising altitude. It causes however a disadvantage of a permanent weight gains, associated with the use of a protective film. In addition, it is difficult to attach the foil, to keep it under control and then to get back on, particularly for large commercial aircraft.

A plane's surface, which will be replaced after having reached the cruising altitude. Insofar as biocatalysis proteins are used, active decomposition of insect deposits may be achieved. It is however of disadvantage since with time the biocatalysis protein is strongly decreased, and a renewal of the coating is expensive. It is also of a disadvantage that with the coating is added a permanent weight gain.

In contrast, the U.S. 2012/0160963 A1 describes a temporary coat which can be replaced and will not cause a drag. In this context, systems are proposed of which their material reacts to UV radiation, temperature or humidity differences, so the coating can be replaced. In this context, are described enzymes which attack the coating and dissolve it. However there is a disadvantage of a permanent weight gain, associated with the use of this protective film.

There are also attempts to temporarily remove the insect deposits by employing liquid films or gels, which are gradually removed by the air resistance. It turns out however, that often the result in the use of enzyme mixtures, due to the complex interaction between the individual enzymes causes an unwanted deactivation that affects the activity of the enzyme mixture to no longer be sufficient to dissolve the insect deposits from the surface of the aircraft.

In this context, it is important to note that usually an aqueous environment is required for a high enzyme activity. However the air humidity drops with increasing altitude and previously applied aqueous films freeze during the climb to cruising altitude. This way the beneficial effect of the aqueous environment can no longer be sustained. The biocatalysis action of the enzymes is confined therefore normally to the short period between takeoff and reaching of the cruising altitude, so that a particularly high enzyme activity is required for these systems.

Insofar, besides the enzyme mixture other substances such as surfactants or de-icing fluid should be added. Yet the problem of unwanted deactivation is reinforced by any particular chemical inhibition of the enzyme activity.

### BRIEF SUMMARY OF THE INVENTION

In view of the foregoing, an aspect of the present invention provides a cleaning mixture for the removal or avoidance of insect deposits on aircraft surfaces, in which the results from the prior technique disadvantages do not occur. It is a further aspect of the present invention, that a cleaning mixture to remove or prevent insect deposits provided for aircraft surfaces, may be added in which additional substances, such as surfactants and/or de-icing agents will not have the enzyme activity reduced by interaction between the various substances, thus, cause an effective dissolution of the insects deposits in the short period between takeoff and reaching the cruise altitude.

The present invention relates to a cleaning mixture for the removal or avoidance of insect deposits on surfaces, preferably aircrafts, in particular of the removal or avoidance of insect deposits on wings, fuselage or tail of an aircraft, as described:
i) Enzymes, selected from at least a protease in combination with at least a chitinase
ii) At least, a surfactant, and optional
iii) De-icing agent.

Under the framework of “Enzyme” is a substance, usually a protein, as understood, that can catalyze without being consumed one or more reactions, in particular biochemical reactions, within the scope of this invention. This lowers the activation energy of the reaction catalyzed, and accelerates the reaction. The catalytic center is responsible for the catalytic efficiency of the enzyme. At this point, the enzyme binds to the substrate. The active center of the enzyme molecule specificity affects the enzymatic catalysis, with a three-dimensional structure complementarily of the enzyme and the substrate surface, which is required for effective catalysis. Within the context of this invention, the term “Enzyme” includes also catalytically active ribozymes.

Usually different enzymes are needed for different substrates.

As explained above, insect deposits consist mainly of the exoskeleton and the hemolymph. The exoskeleton is composed, mostly of the polysaccharide chitin while the hemolymph is composed of proteins. Due to the different substrate specificity, it is therefore advantageous if an enzyme mixture is used to effectively accelerate the degradation reactions of the different components of the insect deposits.

Proteases are enzymes that are able to breakdown the proteins in the hemolymph of the insects into short-chain peptides and individual amino acids, which show a higher solubility of proteins and exhibit a protic solvents and therefore is easier to remove. Chitinase are enzymes that are able to break the glycosidic bonds and to convert it to chitin in Monosaccharides or short-chain oligosaccharides, which have a higher solubility in the protein tables and exhibit a protic solvents and therefore easier to be removed.

It could be shown that it is advantageous to deploy proteases with chitinase for the removal or avoidance of insect deposits in purification mixtures. It is especially beneficial to use a mixture of a protease and a chitinase.

Especially preferred, is at least a protease which includes the commercially available protease 3111, or protease 5860. Also especially preferred, is at least a chitinase which includes commercially available chitinase SG.

A preferred embodiment of the invention detergent includes the protease 3111 in combination with chitinase SG.

A more preferred embodiment of the invention detergent includes protease 5860 in combination with chitinase SG.

A further preferred embodiment of the invention detergent includes protease 3111 and protease 5860 in combination with chitinase SG.

Protease 3111 is from Bacillus sp. derived protease with CAS number 9036-06-0 and is commercially available, for example, under P3111 by Sigma-Aldrich.

Protease 5680 is from Bacillus sp. derived protease with CAS number 9036-06-0 and is commercially available, for example, under P3111 by Sigma-Aldrich.

Chitinase SG is derived from Streptomyces griseus protease with CAS number 9001-06-3, and is commercially available, for example, under C6137 by Sigma-Aldrich.

In more preferred embodiments the cleaning mixture includes at least more enzymes, in addition to the above mentioned combinations of protease and chitinase, i.e. selected from the group consisting of amylase, lipase, cellulase, and nuclease.

A further preferred variant of all these forms of execution is at least a lipase that can be included in next to the enzymes, selected from at least a protease in combination with at least a chitinase. The lipase is preferably selected from the group consisting of thermus thermophilus lipase, thermus flavus lipase, aspergillus oryzae lipase, mucor miehei lipase, porcin pancreas lipase, pseudomonas cepacia lipase, rhizopus arrhizus lipase, rhizopus niveus lipase, candida cylindracea lipase, candida antarctica A lipase, candida antarctica B lipase, candida rugosa lipase, thermomyces lanuginosus lipase, rhizomucor miehei lipase, rhizomucor expansum lipase, penicillium camemberti lipase, penicillium roqueforti lipase, aspergillus niger lipase, burkholderia cepacia (Pseudomonas) lipase, pseudomonas fluorescens lipase, rhizopus niveus lipase, rhizopus oryzae lipase, mucor javanicus lipase, alcaligenes sp. lipase, porcine of pancreas lipase, particularly favors pseudomonas stutzeri lipase, porcine pancreas phospholipase, thermomyces species phospholipase A1, and preferred mixtures, aspergillus niger amanolipase A, porcine pancreas type II lipase and/or porcine pancreas pancreatinlipase.

In this context it should be noted that the enzyme activity is influenced by various factors. Especially in mixtures, it may be that individual components of the mixtures might be chemical inhibitors and greatly reduce the enzyme activity. In this context, it is known that the presence of one enzyme can adversely affect the activity of another enzyme.

It is therefore useful that the components of enzyme mixture are coordinated, so that a reduction of the enzyme activity of individual contained enzymes is avoided whenever possible. This can if necessary be determined in the way of routine experiments, like measurements of activity by a professional.

In one embodiment the invention, the cleaning mixture includes no other enzymes by the protease and/or chitinase.

In another embodiment, the cleaning mixture invention includes no further enzymes in addition to protease 3111, or protease 5860 and chitinase SG.

It is also known that a variety of other organic and inorganic substances chemically have an inhibiting effect on the enzyme activity. This applies to organic and inorganic solvents, as well as organic and inorganic surfactants and de-icing.

It is therefore within the scope of the present invention that other components would makes sense in the cleaning mixture, according to the invention for the removal or avoidance of insect deposits, in addition to the enzymes, and so to select and coordinate that a reduction of enzyme activity is avoided.

To improve the cleaning effect of the invented cleaning mixture it is preferably compatible with the use of enzymes, i.e. in which the enzyme activity does not, or would not significantly reduce the surfactants used. “Surfactant” is in the context of this invention a substance, as understood, that lowers the surface tension of a liquid, or the Inter-facial tension between two phases and allows the formation of dispersions or supports it. Surfactants are amphipathic, and consist of a hydrophobic and a hydrophilic part of the molecule, while the hydrophilic part of the molecule has a cationic, anionic or strong polarizing character.

In one embodiment of the cleaning mixture invention, there is at least a surfactant which is selected from the group consisting of alkyl carboxylic acid salt, aryl carboxylic acid salt alkyl aryl carboxylic acid salt alkyl sulphonate, aryl sulfonic acid sodium salt, alkylarylsulfonate, alkyl sulfate, aryl sulfate, alkylarylsulfate, alkylpolyglycolethersulfate, alkylphenolpolyglycolethersulfate, alkylpolyglycolether, alkylphenolpolyglycolether, acylpolyglycolether, oxethyliertes Sulfonamid, oxethylierte amide, alkylpolyglycosid, alkylaminhydrohalogenide, alkyltrimethylammoniumhalogenide, alkylpiridinuimhalogenide, polyphosphate, poly silicate, polyol, polyoxypropylenalkylether, polyoxypropylenalkylphenolether, and mixtures thereof.

In a further embodiment the cleaning mixture invention there is at least a surfactant selected from the group consisting of natriummetasilicate sodium naphthalene 2-sulfonic acid salt, sodium tripolyphosphate, cholic acid, polyethylene block polyethylene glycol copolymer, Las-C10, natriumundecylbenzolsulfonate, natriumdodecylbenzolsulfonate, polyethyleneglycole(1,1,3,3-tetramethylbutyl)phenylether, glycerol, oxirane with N-propyl-N-[2-(2,4,6-trichlorophenoxy)ethyl]imidazole-1-carboxamide and their blends, in particular polyethyleneglycole(1,1,3,3-tetramethylbutyl)phenylether or glycerol.

In a further embodiment the cleaning mixture invention there is a polyol and/or polyoxyethylenalkylphenylether with no additional surfactants.

In another embodiment, the cleaning mixture invention, besides polyethylenglycole(1,1,3,3-tetramethylbutyl) phenylether and/or glycerol, includes no additional surfactants.

As explained above, the troublesome contamination of the aircraft exterior, which can lead to the formation of turbulent flows includes not only insect debris but also deposits of frozen water. It is therefore a usual practice, especially in the winter, to use de-icing agents to treat the aircraft exterior. In the context of this invention, “de-icers” are fluids which cause the melting of ice or frost on the surface. They act to melt or reduce accumulation. De-icers are usually mixtures of monohydric alcohol, or glycols and water in general.

If in addition to the removal or avoidance of insect debris, also a de-icing effect is desired, so the cleaning mixture invention may also include a de-icing fluid.

Insofar as the cleaning mixture invention with the enzymes and surfactants, it also makes sense to include de-icing fluid agents, taking into consideration the other components of the cleaning mixture as agreed, where a reduction of the enzyme activity is avoided whenever possible.

In one embodiment the cleaning mixture invention is at least a de-icing selected from the group consisting of de-icing fluid type I, de-icing fluid type II, de-icing fluid type III, de-icing fluid type IV, and mixtures thereof.

The de-icing fluid types I to IV according to ISO/SAE are common and well known to the professional people in the aviation industry. The de-icing fluid type I to IV contains a mixture of glycol and water. The de-icing fluid types II to VI also contain a thickener, so that they better adhere to the treated surface. The thickening agent is usually of an organic basis to used normally, particularly poly acrylic acid, polymethacrilyc acid, polyacrylamide, cellulose ethers, polyethylene glycols, polyvinylpyrrolidone, polyvinyl alcohols, polyethylene oxide, and xanthan gum.

De-icing I according to SAE/ISO type I is according to AMS 1424 and ISO 11075.

De-icing II according to SAE/ISO type II is according to AMS 1428 and ISO 11078.

De-icing IV in accordance with SAE/ISO type IV is according to AMS 1428 and ISO 11078.

As already explained, the cleaning mixture should develop its effectiveness between takeoff and the reached cruising altitude. It is therefore appropriate to adjust the viscosity of the mixture of cleaning so high, that it adheres in sufficient quantities, to the treated surface. It can be beneficial, if the cleaning mixture invention will contains thickening agents, especially if no de-icing fluid or a de-icing fluid without thickening agent is used.

In a preferred embodiment the cleaning mixture invention, there should be at least a thickening agent selected from the group consisting of polyacrylic acid, polymethacrylic acid, polyacrylamide, cellulose ethers, polyethylene glycol, polyvinylpyrrolidone, polyvinyl alcohol, polyethylene oxide, or xanthan gum.

In a further embodiment of the cleaning mixture in addition to the de-icing there is a thickening agents, in particular thickening agent selected in addition from the group consisting of polyacrylic acid, polymethacrylic acid, polyacrylamide, cellulose ethers, polyethylene glycol, polyvinylpyrrolidone, polyvinyl alcohol, polyethylene oxide, xanthan gum or mixtures thereof.

The viscosity of the cleaning mixture invention is at 20° C., preferably in a range from 100 to 20,000 mPas as further preferred from 1000 to 20,000, further preferred from 2000 to 20,000 mPas, further preferred from 1000 to 20,000 mPas, further preferred from 2000 to 20,000 mPas, further preferred from 5000 to 20,000 mPas, further preferred from 10000 to 20,000 mPas, in particular from 10,000 to 15,000.

It is well known that the structure of proteins is dependent on the pH of the material which surrounds them. Because the structure of the protein has a decisive influence on the activity of the enzyme, the pH of the material surrounding the proteins must be set in an appropriate manner to achieve a high enzyme activity.

In one embodiment, the pH value of the cleaning mixture invention is in a range from 4 to 14, preferably 5 to 12, with next preferred is 7 to 12, or 7 to 11, yet in particular 8 to 10.

Some of the features of the cleaning mixture, in particular the viscosity and pH, can be set to be suitable by the addition of water, organic and/or inorganic acids and/or bases in the usual professional manner. In addition to or instead of water, if necessary, other solvents can also be used, for example, alcohol, ether, etc.

In one embodiment, the cleaning mixture invention includes surfactants, enzymes and water. In a specific embodiment, the cleaning mixture invention along with surfactants, enzymes and water includes no other components.

In another embodiment, the cleaning mixture invention includes enzymes, surfactants, de-icing fluid and water. A particular embodiment of the invention comprises in addition to cleaning mixture enzymes, also surfactants, de-icing and water with no other ingredients.

In another embodiment, the invention cleaning mixture includes enzymes, surfactants and de-icing agents, thickening agents and water. A particular embodiment of the invention comprises in addition to cleaning mixture enzymes, also surfactants, de-icing thickener and water with no other ingredients.

It is professionally known that the properties of a mixture do not only depend on the individual components, but also on their ratios.

In one embodiment of the invention, the cleaning mixture includes enzymes in a total of 0.1 to 50 GEW.-percent, preferably 0.1 to 20 GEW. %, or further preferably 0.1 to 10 GEW. %, with next preference of 0.3 to 5 GEW. %, or further GEW. % of 0.5 to 5 and preferred in particular is 0.5-2 GEW % relative to the mass of the cleaning mixture.

The ratio of protease to chitinase is located in an area of 99:1 to 1:99, preferably 90:10 to 10:90 or further preferred 80:20 to 20:80, or preference of 70:30 to 30:70, or further preference of 60:40 to 40:60, in particular 50:50.

Furthermore the cleaning mixture includes surfactants in a total of 0.1 to 50 GEW.-percent, preferably 0.1 to 30 GEW. % with next preference of 0.5 to 20 GEW % next preference of 1-20 GEW. % or more preferred 5 to 15 GEW.-percent, especially 5-10 GEW %, based on the mass of the cleaning mixture.

In a specific embodiment of the invention, the cleaning mixture also includes de-icing fluid in a total quantity between 1 and 99 GEW %, preferably 10 to 99 GEW. %, next preference of 20 to 95 GEW. %, next preference of 30 to 95 GEW. %, next preference of 40 to 95 GEW. %, next preference of 50 to 95 GEW. %, especially 60 to 95 GEW. %, related to the mass of the cleaning mixture.

There are also forms of embodiment where the proportion of the de-icing fluid in the cleaning mixture is of ≦50 GEW. %, preferably 1 to 50 GEW. %, of a preference of 1-40 GEW. % in a range of 5 to 30 GEW.-percent, or preferably especially 5-15 GEW %.

Demonstrated in the context of this invention, it may be shown that in cleaning mixtures with enzymes, surfactants and/or de-icing agents the enzyme activity compared to the pure enzyme activity method can be increased, inasmuch as certain enzymes are combined with specific surfactants or de-icing agents. In other words it is demonstrated, that the enzyme activity is enhanced by the combination of specific surfactants and/or de-icing agents through synergistic effects.

In a preferred embodiment, the cleaning mixture includes protease 3111 and sodium tripolyphosphate, polyethylenglycole (1,1,3,3-tetramethylbutyl) phenylether or glycerol.

In a more preferred embodiment, the cleaning mixture includes protease 5860 and alkylsulphate Polyethylenglycolalkylester, especially in a mixture of trisodium phosphate, Isotridecanol (ethoxyliert) and sodium alkyl sulfate and/or a mixture of polyethylenglycolphosphate dioctylester and polyethylenglycolphosphate octylester.

In a more preferred embodiment the cleaning mixture chitinase SG and polyethyleneglycole (1,1,3,3-tetramethylbutyl) phenylether, includes sodium tripolyphosphate and/or Cholic acid.

The invention relates to the use of the described cleaning mixture in the removal or avoidance of insect deposits on surfaces, preferably aircraft surfaces, in particular the removal or avoidance of insect deposits on wings, fuselage or the tail of the aircraft.

Also the invention relates to a process for the removal or avoidance of insect deposits from aircraft surfaces, preferably, in particular, the removal or avoidance of insect debris on wings, fuselage or the tail of an aircraft with the following steps:

i) Applying a cleaning mixture on the surface to be treated,

ii) Cause the activity of the cleaning mixture on the surface,

iii) Remove the cleaning mixture.

The cleaning mixture invention is used as a cleaning mixture.

Applying is preferably by spraying or by means of other specially known procedures for the application of substances on surfaces, preferably aircraft surfaces, in particular procedures for the application of substances on wings, fuselage or the tail of the aircraft.

At least a portion of the treated surface should be covered with the cleaning mixture.

It is especially useful, that at least 90% or at least 10% of the surface to be treated with the cleaning solution, is covered preferably at 30% or further preferred at 50%, or at least 60%, or at least 80% to 90%.

It is still useful if the application of the cleaning mixture on the treated surface will be for a period from 10 to 720 minutes, preferably 10 to 360 minutes or further preferred 10 to 240 minutes or 10 to 120 minutes, or further in particular 10-60 or 10 to 30 minutes.

The removal of the cleaning mixture is usually automatically by expiration of the treated surface. The expiration process is supported by the air resistance, when the treated surface is moved.

In a specific embodiment the cleaning mixture invention is applied on a primed surface, preferably a pretreated hydrophobic surface, particularly on a primed polyurethane or epoxy surface. By pre-treatment of the surface, to improve the adhesion of the cleaning mixture, whereby there is a permanent coating of the pre-treated surface, can be achieved through training of covalent bonds between one or more components of the cleaning mixture and functional groups of the pre-treated surface.

In this context, where 2009/136186 A1 reference, it describes the activation of surfaces with —NH2, —COOH, —CHO, and OH groups, as well as the treatment with enzymes and/or de-icing agents. This relevant revelation of the 2009/136186 A1 in the framework of the present invention, can advantageously be used.

The enzyme is not directly connected in this embodiment to the surface, but a so-called spacer is preferably used. It is covalently linked with the surface to be treated, and the enzyme in turn temporarily or permanently is bound to the spacer.

The pre-treatment of the surface includes applying the spacer so that the spacer, under consideration of the functional groups of the surface to be treated, is selected.

The surface of carboxyl groups to be treated, should includes the spacer with preferably at least a carbodiimide group.

The surface amine groups to treat the spacer should includes preferably at least an N-hydroxysuccinimide group, an Imidoester group, a pentafluorophenyle group, a hydroxymethylphosphine group, or mixtures thereof.

The surface to be treated of the sulfhydryl groups, which contains the spacer should includes preferably at least a malamud group, a bromoactyl group, an Iodoacetyl group, a pyridyldisulfid group, a vinylsulfon group, or a mixtures thereof.

The surface to be treated with aldehyde group should include the spacer preferably at least with a hydrazide group.

The surface to be treated containing hydroxyl groups, should includes the spacer preferably at least of an isocyanat group.

In a specific embodiment of the spacer may include diazirin—and/or aryl azide groups, regardless of the functional groups of the surface to be treated.

Surfaces are with nucleophilic functional groups, such as amine or hydroxyl groups, will preferably first be pretreated with spacers with at least two electrophilic functional groups, and then with the invention contact cleaning solution. The spacer is in this connection was preferably selected from the group consisting of glutaraldehyde, trichloroacetonitrile, epichlorohydrin, 1,4-bis(2,3-epoxypropoxy) butan, n-methyl-5-phenyl isoxazole-3′-isoxazole sulfonate, n-ethyl-5-phenyl-3′-sulfonate, chloroanhydrid of 4-nitrobenzoe acid and their mixtures.

Surfaces treated with at least two nucleophilic functional groups, then with a second spacer with at least two electrophilic functional groups, and affiliated with the cleaning solution invention should be placed in contact with two electrophilic functional groups. The first spacer is, in this context, preferably selected from the group consisting of from hydrazine, diaminoethane, diaminopropane, diamino, diaminopentane, hexanediamine, diaminoheptane diaminooctane, dihydroxyethane, dihydroxypropane, dihydroxy butan, dihydroxypentane, dihydroxyhexane, dihydroxyheptane, dihydroxyoctane, or mixtures thereof. The second spacer is in this connection preferably selected from the group consisting of glutaraldehyde, trichloroacetonitrile, epichlorohydrine, 1,4-bis(2,3 epoxypropoxy) butan, n-methyl-5-phenyl isoxazole-3′-isoxazole sulfonate, n-ethyl-5-phenyl-3′-sulfonate, chloroanhydride of the 4 nitrobenzoe acid or mixtures thereof.

In a more preferred embodiment the spacer for surfaces with electrophilic functional groups, is selected respectively from Nucleophilic functional groups preferably from the group consisting of Allyl(4-methoxyphenyl)dimethylsilan N-alloc-1,6-hexanediaminhydrochlorid, N-alloc-1,6-hexanediaminhydrochlorid, N-alloc-1,3-propanediaminhydrochlorid, 6-(allyloxycarbonylamino)-1-hexanol, 3-(allyloxycarbonylamino)-1-propanol, 4-aminobutyraldehyddiethyl acetal, N-(2-aminoethyl), maleimidtrifluoroacetat, benzyl-N-(3-hydroxypropyl)carbamat, 4-(boc-amino) butylbromid, 2-(boc-amino) ethanethiol, 2-[2-(boc-amino) ethoxy]ethoxyessig acid-(dicyclohexylammonium), 2-(boc-amino) ethyl bromide, 6-(boc-amino)-1-hexanol, 6-(boc-amino) hexylbromid, 5-(boc-amino)-1-pentanol, 3-(boc-amino)-1-propanol, 3-(boc-amino) propylbromid, 15-(boc-amino)-4,7,10,13-tetraoxapentadecan acid, N—BOC-1,4-butane diamine, N—BOC-cadaverin, N—BOC-ethanolamin, N—BOC-ethylendiamin, N—BOC-2,2′-(ethylendioxy) diethylamin, N—BOC-1,6-hexane diamine, N—BOC-1,6-hexane diamine hydrochloride, N—BOC-4-isothiocyanatoanilin, N—BOC-4-isothiocyanatobutylamin, N—BOC-2-isothiocyanatoethylamin, N—BOC-3-isothiocyanatopropylamin, N—BOC—N-methyl ethylendiamin, N—BOC-m phenylenediamine, N—BOC-p-phenylenediamine, 2-(4-Boc-1-piperazinyl)essig acid, N—BOC-1, N-(4-bromobutyl) phthalimid 3-propan-diamin, N—BOC—N′-succinyl-4,7,10-trioxa 1.13 tridecandiamin, N—BOC-4,7,10-trioxa 1.13 tridecandiamin, N—BOC-4,7,10-trioxa 1.13 tridecandiamin, 4-bromobutyr acid, 4-bromobutyrylchlorid, N-(2-Bromoethyl) phthalimid, 6-bromo-1-hexanol, N-succinimidylester 3-(bromomethyl)benzoe acid, 4-(bromomethyl) phenylisothiocyanat, 8-bromo octane acid, 8-bromo octane acid, 8-bromo-1-oktanol, N-(3-bromopropyl) phthalimid, 4-(tert-butoxymethyl)benzoe acid, tert-butyl-trans-17-bromo-4,7,10,13-tetraoxa-15-heptadecenoat, tert-butyl 4-hydroxybutyrate, chloral hydrate, 4-(2-chloropropionyl) phenylessig acid, 1.11 diamino-3,6,9-trioxaundecan, di-BOC-cystamin, diethyleneglycolmonoallylether, 3,4-dihydro-2H-pyran-2-methanol, 4-[(2,4-dimethoxyphenyl) (Fmoc-amino) methyl]phenoxyessig acid 4-(Diphenylhydroxymethyl)benzoe acid, 4-(fmoc-amino)-1-butanol, 4-(fmoc-amino) butylbromid, 2-(fmoc-amino) ethanol, 2-[2-(fmoc-amino) ethoxy]ethylaminhydrochlorid, 2-(fmoc-amino) ethylbromid, 6-(Fmoc-amino)-1-hexanol, 5-(fmoc-amino)-1-pentanol, 3-(fmoc-amino)-1-propanol, N-Fmoc-2-bromoethylamin, N-fmoc-1,4-butandiaminhydrobromid, N-fmoc-ethylendiaminhydrobromid, N-Fmoc-1,6-hexandiaminhydrobromid, N-Fmoc-1,3-propandiaminhydrobromid, N-fmoc-N″-succinyl-4,7,10-trioxa-1,13-tridecandiamin, (3-formyl-1-indolyl) acetic acid, 6-guanidinohexan acid, 4-hydroxybenzyl alcohol, N-(4-hydroxybutyl)trifluoroacetamid, 4′hydroxy-2,4 dimethoxybenzophenone, 4-[4-(1-hydroxyethyl)-2-methoxy-5-nitrophenoxybutyr acid, N-(2-hydroxyethyl)trifluoroacetamid, N-(6-hydroxyhexyl)trifluoroacetamid, 4-(4-Hydroxymethyl-3-methoxyphenoxy) butyr acid, 4-hydroxy-2-methoxybenzaldehyde, 4-hydroxy-3-methoxybenzyl alcohol, 4-hydroxymethyl-3-methoxyphenoxyessig acid, 4-(hydroxymethyl) phenoxyessig acid, 3-(4-hydroxymethylphenoxy) propion acid, N-(5-hydroxypentyl)trifluoroacetamid, N-(3-hydroxypropyl)trifluoroacetamid, 2-maleimidoethylmesylat, 4-Mercapto-1-butanol, 6-Mercapto-1-hexanol, phenacyl 4-(bromomethyl) phenylacetat, 4-Sulfamoylbenzoe acid, 4-Sulfamoylbutyr acid, N-Trityl 1.2 ethandiaminhydrobromide, 4-(Z-Amino)-1-butanol, 6-(Z-amino)-1-hexanol, 5-(Z-amino)-1-pentanol, 3-(Z-Amino)-1-propanol, N—Z-1,4-butandiaminhydrochlorid, N—Z ethanolamine, N—Z-ethylendiaminhydrochlorid, N—Z-1,6-hexandiaminhydrochlorid, N—Z 1.5 pentandiaminhydrochlorid, N—Z-1,3-propandiaminhydrochlorid.

Between or during the procedure steps, one or more cleaning and/or processing steps, preferably using organic or inorganic acids, organic and/or inorganic bases, organic and/or inorganic buffer or water and particularly a phosphate buffer, may be performed. The surface is to be dried after the treatment with the cleaning solution invention.

Application of the cleaning mixture invention or the surface treatment with the invention, can be done immediately before the start, for example during the defrosting operation. It is also possible that the application of the cleaning mixture invention or the inventive treatment of the surface, will take place during regular cleaning or maintenance.

### BRIEF DESCRIPTION OF THE FIGURES

FIG. 1 shows the determination of the relative enzyme activity of 3111 protease and protease 5860 at different pH values.

FIG. 2 shows the determination of the relative enzyme activity of 3111 protease and protease 5860 in a buffer at pH 9.0 at 2-4° C.

FIG. 3 shows the determination of the relative enzyme activity of 3111 protease and protease 5860 in a buffer at pH 9.0 at 70° C.

FIG. 4 Determining the relative enzyme activity of chitinase SG shows at 24° C. in buffer at pH 9.0 and pH 6.0.

FIG. 5 Determining the relative enzyme activity of chitinase SG shows at 50° C. in buffer at pH 9.0 and pH 6.0.

FIG. 6 shows the determination of the relative enzyme activity of chitinase SG in the presence of 3111 protease and protease 5860 at 2-4° C.

FIG. 7 shows the determination of the relative enzyme activity of chitinase SG in the presence of 3111 protease and protease 5860 at 20° C.

FIG. 8 shows the determination of the relative enzyme activity of protease 3111 in the presence of different surfactants at 2-4° C.

FIG. 9 shows the determination of the relative enzyme activity of protease 5860 in the presence of different surfactants at 2-4° C.

FIG. 10 shows the determining of the relative enzyme activity of chitinase SG present in the presence of different surfactants at 20° C.

FIG. 11 shows the determination of the relative enzyme activity of protease 5860 in a mixture of de-icing fluid I in 2-4° C.

FIG. 12 shows the determination of the relative enzyme activity of protease 5860 in a mixture of de-icing fluid, in 20° C.

FIG. 13 shows the determination of the relative enzyme activity of protease 5860 in a mixture of de-icing fluid I in 2-4° C.

FIG. 14 shows the determination of the relative enzyme activity of protease 5860 in a mixture of de-icing fluid I in 20° C.

### DETAILED DESCRIPTION

The present invention is discussed further on the basis of the non-restrictive examples below:

### EXAMPLES

The following enzymes were used:

Protease 3111 (CAS number 9036-06-0, p3111 from Sigma-Aldrich), protease 5680 (CAS number 9014-01-1, p5860 Sigma-Aldrich), chitinase SG (CAS number 9001-06-3, C6137 Sigma-Aldrich).

Following surfactants have been used:

Natriummetasilicate (pH 12.5, 307815 Aldrich), sodium 2-naphthalene sulfonate (pH 6.3, 70290 Fluka), sodium tripolyphosphate (pH 8.5, 72061 Sigma-Aldrich), Cholic acid (pH4.3, C1129 Sigma), polyethylene block polyethylene glycol (pH 3.5, 458996 Aldrich), Edisonit (pH 11.5, 637246 Sigma), Triton X-100 (pH 5.5, 93420 Fluka), glycerol (pH 4.4), Terg-a-zyme enzyme detergent (pH 8.6, Z273287 Aldrich), Merpol A (pH 2.2, 421286 Aldrich).

The following surfactant mixtures have been used:

Zestron® VD 200 Zestron, Triton X-100 (10% in water) (CAS number 9002-93-1, T8787 by Sigma-Aldrich), extreme simple green aircraft and precision cleaner (cleaner SG) 13455EU, 70535 by Simple Green Europe.

Following de-icing fluids were used:

De-icing I according to SAE/ISO type I is according to AMS 1424 and ISO 11075

De-icing II according to SAE/ISO type II is according to AMS 1428 and ISO 11078

De-icing IV in accordance with SAE/ISO type IV is corresponding to AMS 1428 and ISO 11078.

### Example 1

The relative enzyme activity of 3111 protease and protease 5860 was determined at different pH values.

The preparation of enzyme solutions was as follows:

1 mL protease was added to 5 mL of an aqueous solution annealed at 37° C. from casein (0.65%). Then the obtained mixture was heated for 10 min at 37° C. was and mixed with 5 mL of an aqueous solution of trichloroacetic acid (100 mmol). Thus the obtained mixture was heated for 30 min at 37° C. and then filtered. 2 mL of the filtrate were then put in a mixture of 5 mL of an aqueous solution of sodium carbonate (500 mmol) and 1 mL of Folin & Ciocalteus's phenol.

The measurement of the enzyme solutions were as follows:

The mixture was heated for 30 min at 37° C., cooled to room temperature and the absorption at 660 nm was determined. The protease activity method was determined with the casein, where one unit (U) protease activity with hydrolyzed casein provided 1.0 μmol of colored equivalent Tryosin. The measurement is performed at 37° C., and the corresponding enzyme optimum pH is adjusted.

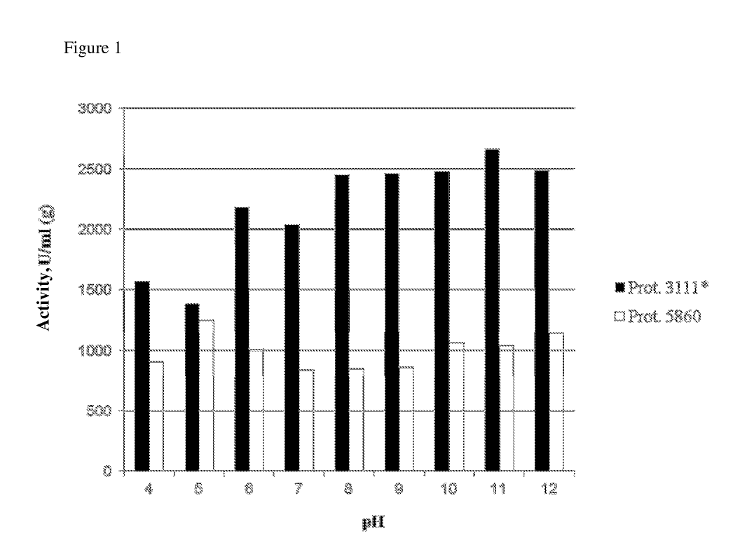

As shown in FIG. 1 it can be seen that protease 3111 and protease 5860 exhibit a relatively stable enzyme activity over the entire range, from pH 4 to pH 12.

### Example 2

The relative enzyme activity of protease 3111 and protease 5860 was determined at different temperatures for a certain period of time. The preparation of enzyme solutions was described under example 1, however the mixture was heated to the performance temperature.

The determination of the relative enzyme activity was done as described in example 1.

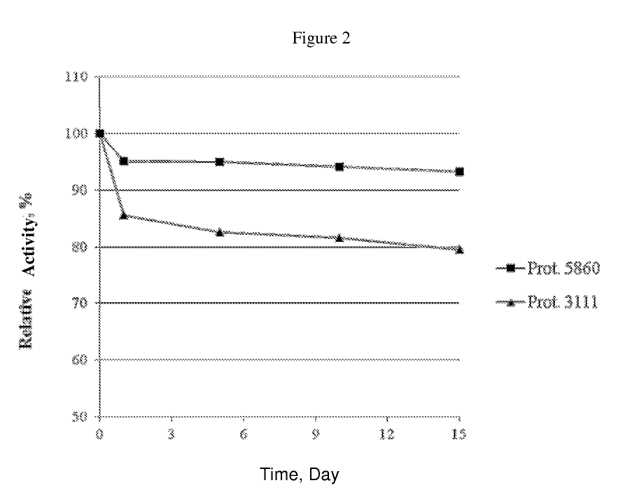

As in FIG. 2, the enzyme activity of protease 3111 and protease 5860 in a temperature range from 2-4° C. is relatively stable, which within the first 48 hours the relative activity is not below 70%.

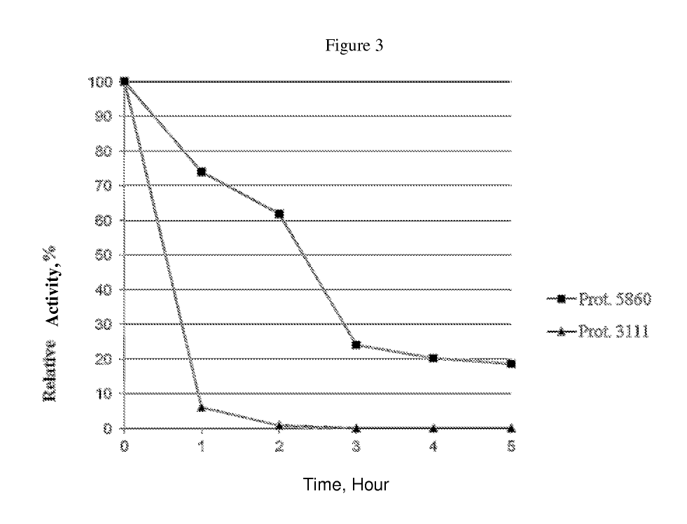

FIG. 3 shows that protease 3111 at a temperature of 70° C. is not stable and the relative enzyme activity falls within an hour to under 10%.

### Example 3

The relative enzyme activity of chitinase SG was determined at different temperatures and different pH values, over a certain period of time.

The preparation of enzyme solutions was as follows:

A suspension of chitin (5 g) in 10 M hydrochloric acid (100 mL) was stirred at room temperature for 2 hours. Then the suspension was put in distilled water (1 L) and the chitin was filtered off. The filtrate (5 g) was placed with a buffer of potassium phosphate (200 mmol) and calcium chloride (2 mmol) and filled up to 95 mL with distilled water. Chitinase SG (0.5 mL) was added to the chitin suspension and heated for 2 hours, while being stirred (200 rpm) to 50° C. Then, the mixture was treated 5 minutes in boiling water, then cooled to room temperature, and 5 min centrifuged (6000 rpm). The resulting solution (2 mL) was a color reaction solution (1.5 mL) that was treated 5 minutes in boiling water, cooled to room temperature, and distilled water (2 mL) was added to the mixture.

The preparation of the color reaction solution was as follows:

Potassium sodium tartrate (12 g) were dissolved in 2 M NaOH (8 mL) and stirred to 3,5-Dinitrosalicylic acid (438 mg) in 20 mL of distilled water (20 mL) and then mixed with distilled water (40 mL).

The measurement of the enzyme solutions were as follows:

First, 50 mg of chitinase SG were dissolved in 25 ml of water. Then 0.5 ML of this solution was subsequently added to 2 mL of a 5% colloidal chitin suspension. The mixture was transferred into cells and treated for 2 hours at 50° C. with a horizontal Shaker at 200 rpm. The cells were placed for 5 minutes in a boiling water bath and then cooled to room temperature. Then, the cells were centrifuged for 5 min at 6000 rpm. 1 ml of the excess solution was added to 1,5 mL 3,5 dinitrosalicyl acid (color agent). The cells were then again placed for 5 minutes in a boiling water bath and cooled to room temperature. Then 2 mL of distilled water were added to the vial and the absorption at 540 nm was determined. One unit (U) of chitinase activity corresponds to 1.0 mg N-acetyl-D glucosamine that is released at 50° C. and pH 6 per hour from the chitin.

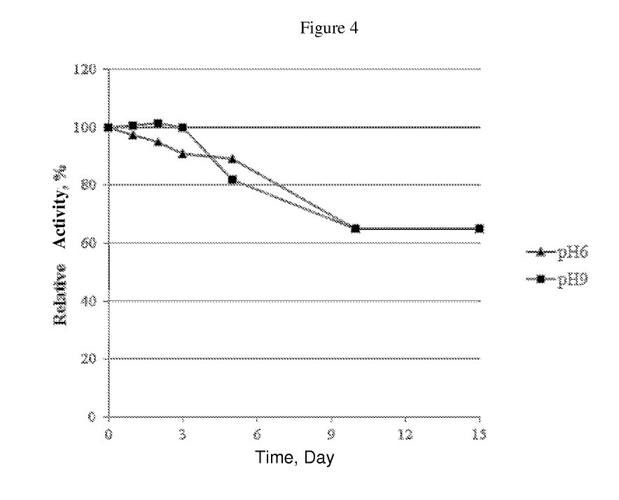

As shown in FIG. 4, the enzyme activity of chitinase SG is relatively stable in a temperature range from 2-4° C. at pH 6.0 and 9.0 pH, then falls within the first 48 hours of relative activity not below 80%.

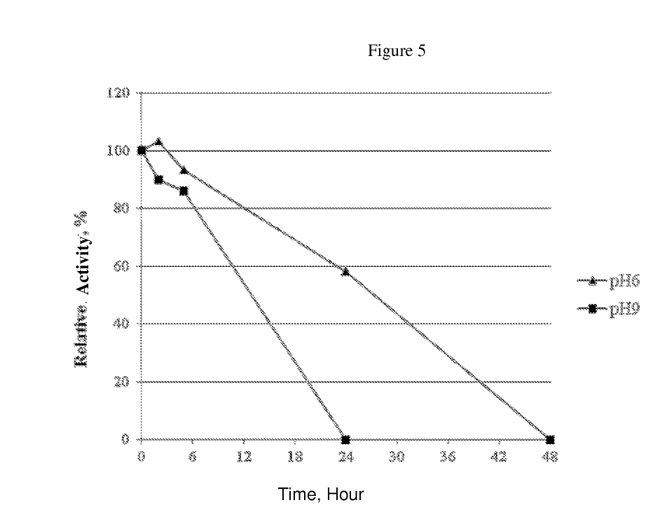

FIG. 5 shows that chitinase SG has a much lower stability at a temperature of 50° C., especially at a pH of 9.0.

### Example 4

The relative enzyme activity of chitinase SG was in the presence of protease 3111 and protease 5860, determined at different temperatures. The preparation of enzyme solutions, as well as the determination of the enzyme activity, took place as in example 1 and example 3 shows, where each 0.6 GEW % enzyme were used.

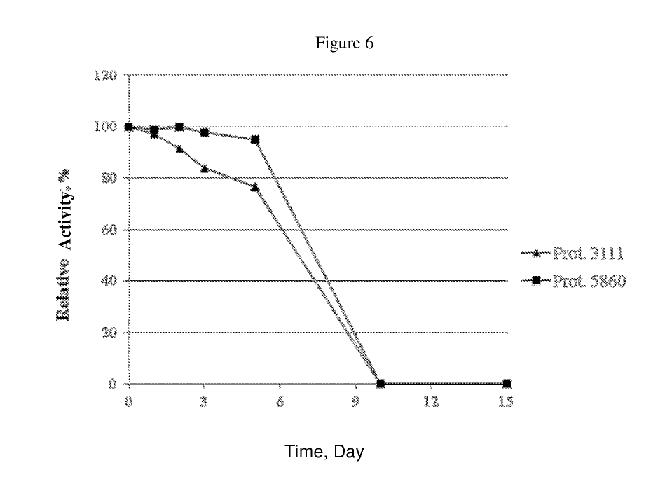

Shown as in FIG. 6, it showed that the enzyme activity reduces chitinase SG in the presence of protease 3111 and protease 5860, however the relative enzyme activity in a temperature range of 2-4° C. is relatively stable, and fall within the first 72 hours of a relative activity not below 80%.

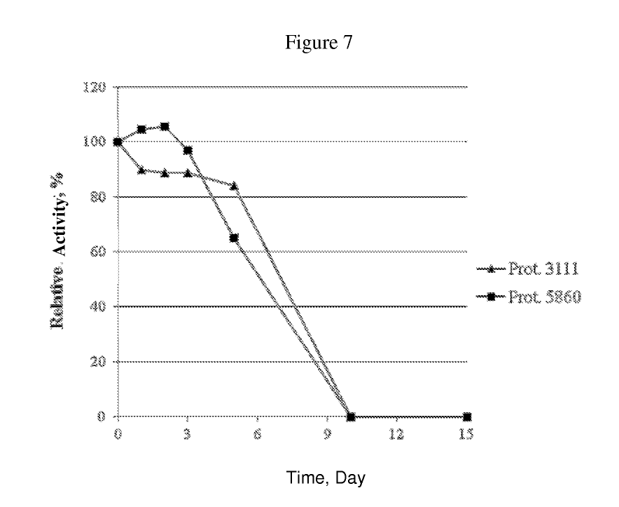

FIG. 7 shows that chitinase SG has a much lower stability in the presence of protease 3111 and protease 5860 at a temperature of 50° C.

### Example 5

The relative enzyme activity of protease 3111, protease 5860 and chitinase SG was determined in the presence of different surfactants. The preparation of enzyme solutions, as well as the determination of the enzyme activity was done as example 1 and example 3 illustrate where 0.6 GEW-% of the enzyme solution with a 1/10 mixture of surfactant and distilled water, was used,

The following surfactants have been used:

### 1: Natriummetasilicate (pH 12.5, 307815 Aldrich)

2: Sodium 2-naphthalene sulfonate (pH 6.3, 70290 Fluka)
3: Sodium tripolyphosphate (pH 8.5, 72061 Sigma-Aldrich)
4: Cholic acid (pH4.3, C1129 Sigma)
5: Polyethylene block polyethylene glycol (pH 3.5, 458996 Aldrich)

### 6: Edisonit (pH 11.5, 637246 Sigma)

### 7: Triton X-100 (pH 5.5, 93420 Fluka)

### 8: Glycerol (pH 4.4)

9: Terg-a-zyme enzyme detergent (pH 8.6, Z273287 Aldrich)

### 10: Merpol A (pH 2.2, 421286 Aldrich)

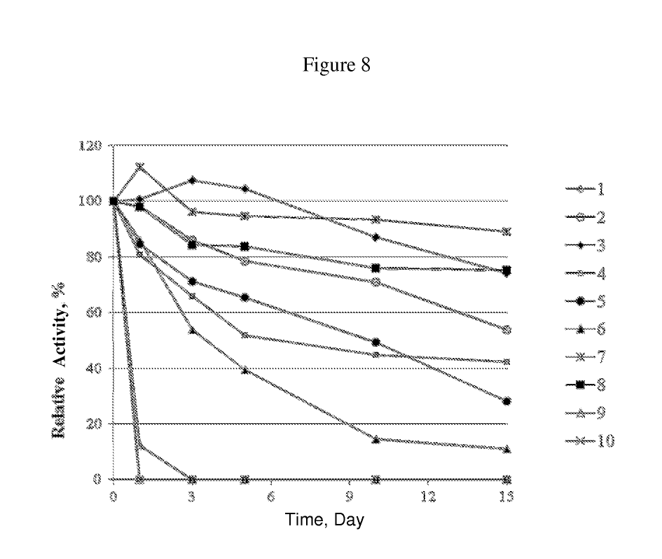

FIG. 8 shows that the stability of protease 3111 can significantly be improved for 2-4° C. when surfactants are used. It has been shown that the relative enzyme activity of protease 3111 in the presence of surfactants, such as Triton X-100 and sodium tripolyphosphate, is increased due to a synergistic effect.

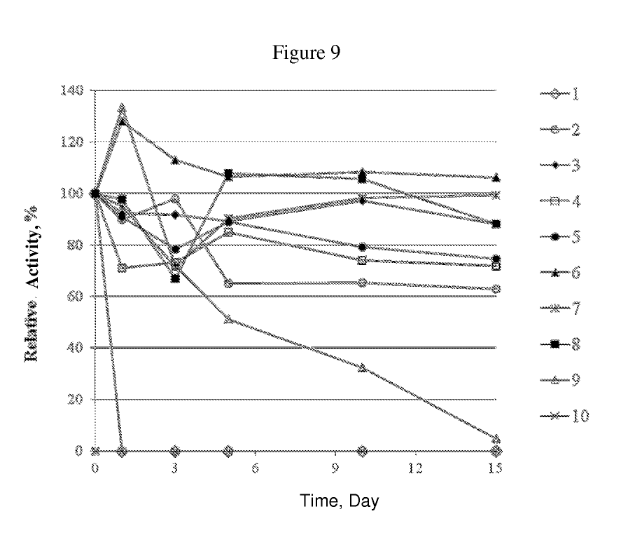

As in FIG. 9 it shows that stability of protease 5860 can be significantly improved when surfactants are used to. It was also shown that the relative enzyme activity surfactant due to a synergistic effect, can be increased for protease 5860 in the presence of surfactants such as Edisonit or Terg-a-zyme enzyme.

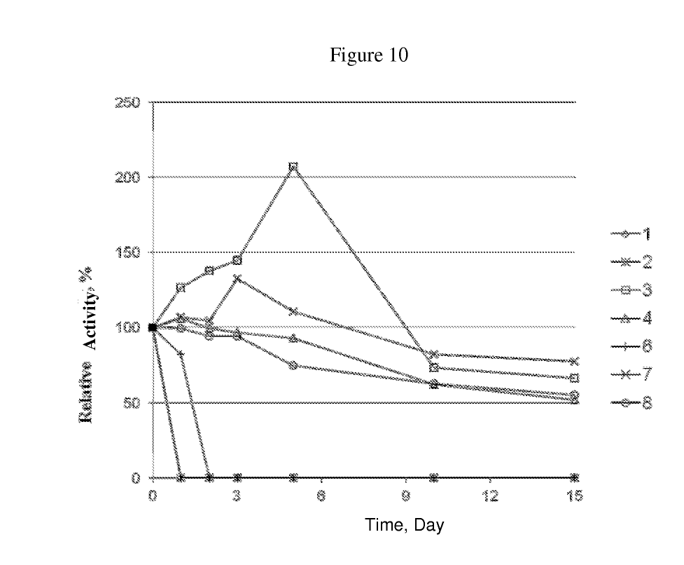

FIG. 10 shows that the stability of chitinase SG can be considerably improved by at 2-4° C. when surfactants are used. It was also shown that the relative enzyme activity of chitinase SG can be increased in the presence of additives such as sodium 2-naphthalene sulfonate, sodium tripolyphosphate, cholic acid, edisonit, or triton X-100 due to a synergistic effect.

### Example 6

The relative enzyme activity of protease 5860 was determined in the presence of various mixtures of surfactants and de-icing agents. Various mixtures of de-icing fluid I and IV with the surfactant Zestron® VD 200 in the mixing ratios of 1:1, 1:3 and 1:5 were tested. The preparation of enzyme solutions, as well as the determination of the enzyme activity, took place as example 1 and example 3 shows, where 0.6 GEW % enzyme were used.

It could be shown that the relative enzyme activity of protease 5860 in the tested mixtures, is stable, with a fall within the first 24 hours of the relative enzyme activity not below 70%. It could also appear, that increasing the relative enzyme activity of protease 5860 in certain mixtures is possible due to a synergy. These mixtures are therefore very well suited for the claimed purpose of application.

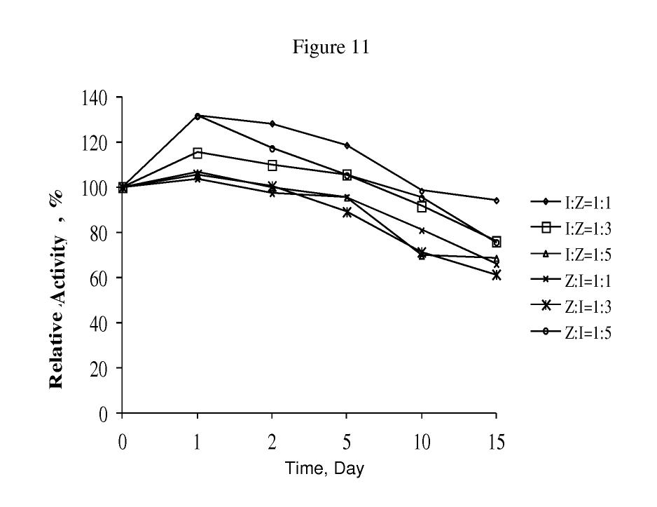

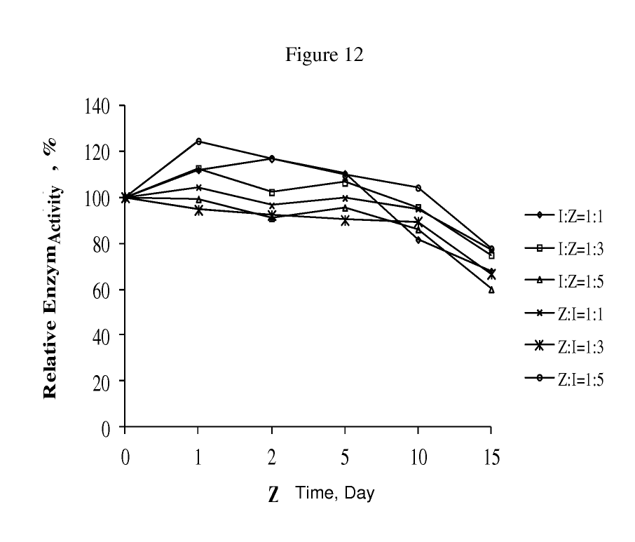

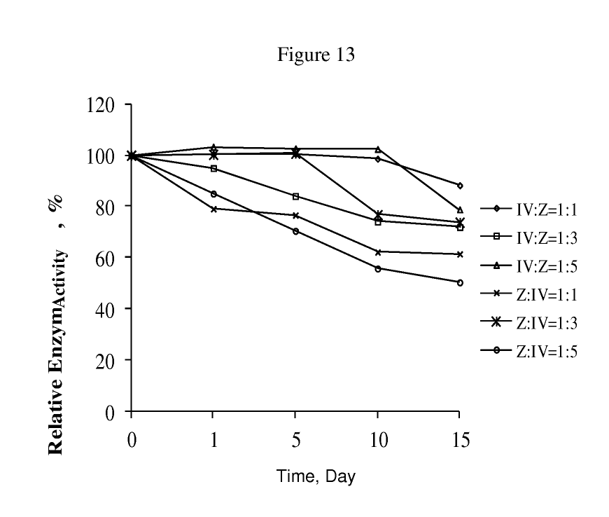

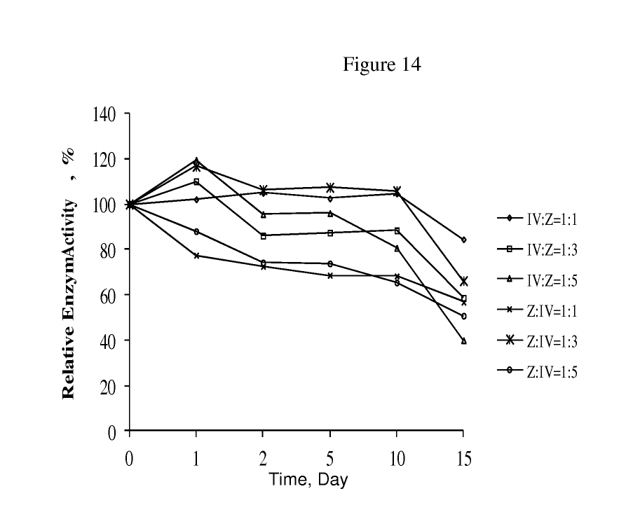

Like from a comparison of FIGS. 11 and 12 with FIGS. 13 and 14, it could appear that mixtures with de-icing IV reduces the relative enzyme activity of protease 5860, more than mixtures with de-icing fluid I. The de-icing IV has therefore, in a comparison with de-icing fluid I a more chemically inhibiting effect on enzyme protease 5860.

Cleaning mixture for the removal/prevention of insect deposits on surfaces

### Practical Example 1

### Triton—100×(92 GEW %),

### Protease 5860 (4 GEW %),

### Chitinase SG (4 GEW %).

### Practical Example 2

### De-icing I (46 GEW %),

### Zestron® VD (46 GEW %), 200

### Protease 5860 (4 GEW %),

### Chitinase SG (4 GEW %).

### Practical Example 3

### Zestron® VD 200 GEW (92%),

### Protease 5860 (4 GEW %),

### Chitinase SG (4 GEW %).

Application of the cleaning mixture for the removal/prevention of insect deposits on a primed surface.

### Practical Example 4a

A polyurethane surface was washed with functional CHO Group 2 hours at 25° C. heat, and distilled water, treated with a solution of glutaraldehyde (2.5 GEW %) in a phosphate buffer, pH 8 (50 mmol) and heated another two hours at 25° C. ate buffer, pH 8 (50 mmol) and heated another two hours at 25° C.

The production of the enzyme solution is done as described in example 1.

### Practical Example 4B

A polyurethane surface was washed with functional CHO Group 2 hours at 25° C. heat, and distilled water, treated with a solution of glutaraldehyde (2.5 GEW %) in a phosphate buffer, pH 8 (50 mmol) and heated another two hours at 25° C. Then the epoxy surface was treated with a mixture of an enzyme solution with protease 5860 (4 GEW %) and de-icing IV and dried at room temperature.

The production of the enzyme solution is done as described in example 1.

### Practical Example 5a

A polyurethane surface with functional NH2 group, was treated with a solution of glutaraldehyde (2.5 GEW %) in a phosphate buffer, pH 8 (50 mmol) and heated for two hours at 25° C. ate buffer, pH 8 (50 mmol) and heated another two hours at 25° C.

The production of the enzyme solution is done as described in example 1.

### Practical Example 5b

An epoxy surface with functional NH2 group was treated with a solution of glutaraldehyde (2.5 GEW %) in a phosphate buffer, pH 8 (50 mmol) and heated for two hours at 25° C. Then the epoxy surface was treated with a mixture of an enzyme solution with protease 5860 (4 GEW %) and de-icing IV and dried at room temperature.

### Practical Example 6a

A polyurethane surface was treated with functional COOH groups 24 hours at 25° C. heat, washed with distilled water and heated 10 min at 50° C., treated with a Dikaliumhydrogenphosphate buffer with pH 7.5 (50 mmol) and heated 2 hours at 25° C. Then the polyurethane surface was treated with a mixture of an enzyme solution with protease 5860 (4 GEW %) and de-icing IV and dried at room temperature.

The production of the enzyme solution is done as described in example 1.

### Practical Example 6b

An epoxy surface was treated with functional COOH groups 24 hours at 25° C. temperature, washed with distilled water and heated for 10 minutes at 50° C., treated with a Dikaliumhydrogenphosphate buffer with pH 7.5 (50 mmol) for 2 hours at 25° C. Then the epoxy surface was treated with a mixture of an enzyme solution with protease 5860 (4 GEW %) and de-icing IV and dried at room temperature.

The production of the enzyme solution is done as described in example 1.

### Practical Example 7a

A polyurethane surface with functional OH group was treated with a mixture of acetone/water/3-Aminopropyl triethoxysilane 1:1.4 0.1, for 1 hour at 25° C. heat, washed with distilled water, with a solution of glutaraldehyde (2.5 GEW %) and heated for 30 minutes at 25° C. Then the polyurethane surface was treated with a mixture of an enzyme solution with protease 5860 (4 GEW %) and de-icing IV and dried at room temperature.

The production of the enzyme solution is done as described in example 1.

### Practical Example 7b

A polyurethane surface with functional OH group was treated with a mixture of acetone/water/3-Aminopropyl triethoxysilane 1:1.4 0.1, for 1 hour at 25° C. heat, washed with distilled water, with a solution of glutaraldehyde (2.5 GEW %) and heated for 30 minutes at 25° C. Subsequently, the polyurethane surface was coated with a mixture of an enzyme solution having protease 5860 (4 parts by weight-%) and treated IV de-icing and dried at room temperature.

The production of the enzyme solution is done as described in example 1.

TABLE 1
Enzyme activity of practical examples 5-7

| | Functional | | Enzyme activity |
|---|---|---|---|
| | group | Surface | (U/cm3) |
| Practical Example 4a | CHO | PU | 0.125 |
| Practical Example 4b | CHO | EPO | 0.189 |
| Practical Example 5a | NH₂ | PU | 0.062 |
| Practical Example 5b | NH₂ | EPO | 0.031 |
| Practical Example 6a | COOH | PU | 0.056 |
| Practical Example 6b | COOH | EPO | 0.042 |
| Practical Example 7a | OH | PU | 0.203 |
| Practical Example 7b | OH | EPO | 0.216 |

Table 1 shows that the different procedures for the immobilization of enzymes on the surface, have a strong influence on the enzyme activity of the coatings as obtained thereof.

1. A cleaning mixture for the removal or avoidance of insect deposits on surfaces, comprises:
i) at least one protease in combination with at least one chitinase; and
ii) at least one surfactant.

2. The cleaning mixture according to claim 1, further comprising at least a de-icing fluid.

3. The cleaning mixture according to claim 1, wherein no other enzymes are included in addition to protease and chitinase.

4. The cleaning mixture according to claim 1, wherein the at least one protease comprises protease 3111 or protease 5860; and
wherein the at least one chitinase comprises chitinase SG.

5. The cleaning mixture according to claim 1, wherein the at least one surfactant is selected from the group consisting of alkyl carboxylic acid salts, aryl carboxylic acid salts, alkyl aryl carboxylic acid salts, alkyl sulphonate, aryl sulfonic acid sodium salt, alkylarylsulfonat, alkyl sulfate, aryl sulfate, alkylarylsulfat, alkylpolyglycolethersulfate, alkylphenolpolyglycolethersulfate, alkylpolyglycolether, alkylphenolpolyglycolether, acylpolyglycolether, oxethylierte sulfonamide, oxethylierte carbon acid amide, alkylpolyglycoside, alkylaminhydrohalogenide, alkyltrimethylammoniumhalogenide, alkylpiridinuimhalogenide, polyphosphate, poly silicate, polyol, polyoxypropylenalkylether, and polyoxypropylenalkylphenolether.

6. The cleaning mixture according to claim 1, where the at least one surfactant is selected from the group consisting of natriummetasilikat, sodium naphthalene 2-sulfonic acid salt, sodium tripolyphosphate, cholic acid, polyethylenPolyethylenglycol copolymer, Las-C10, natriumundecylbenzolsulfonat, natriumdodecylbenzolsulfonat, polyethylenglycol(1,1,3,3-tetramethylbutyl)phenylether, glycerol, oxirane with N-propyl-N-[2-(2,4,6-trichlorophenoxy)ethyl]imidazole-1-carboxamide and mixtures thereof, in particular polyethylenglycol (1,1,3,3-tetramethylbutyl) phenylether and glycerol.

7. The cleaning mixture according to claim 1, wherein no additional surfactants is included in addition to the polyol or polyoxyethylenalkylphenylether.

8. The cleaning mixture according to claim 2, wherein the de-icing is selected from the group consisting of de-icing fluid type I, de-icing fluid type II, de-icing fluid type IV and mixtures thereof.

9. The cleaning mixture according to claim 1, further comprising at least one thickening agent.

10. The cleaning mixture according to claim 9, wherein the at least one thickener is selected from the group consisting of polyacrylic acid, polymethacrylic, polyacrylamide, cellulose ethers, polyethylene glycols, polyvinylpyrrolidone, polyvinyl alcohols, polyethylene oxide, and xanthan gum.

11. The cleaning mixture according to claim 1, wherein the viscosity of the cleaning mixture at 20° C. is in at least one of the ranges of:
100 to 20,000 mPas;
1000 to 20,000 mPas;
2000-20,000 mPas;
1000 to 20,000 mPas;
2000-20,000 mPas;
5000-20,000 mPas;
10000 up to 20,000 mPas; and
10,000 to 15,000 mPas.

12. A method for the removal or avoidance of insect deposits from surfaces, comprising:
i) applying a cleaning mixture according to claim 1 on the surface to be treated;
ii) retaining the cleaning mixture on the surface for a period of from 10 to 720 min.; and
iii) removing the cleaning mixture.
